(19) United States
(12) Patent Application Publication
(10) Pub. No.: US 2010/0002699 A1
(43) Pub. Date: Jan. 7, 2010

(54) PACKET TAGGING FOR EFFECTIVE MULTICAST CONTENT DISTRIBUTION

(75) Inventors: Fredrik Carpio, San Diego, CA (US); Milton Massey Frazier, San Marcos, CA (US); Nikolaos Georgis, San Diego, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/165,820

(22) Filed: Jul. 1, 2008

(51) Int. Cl. H04L 12/56

(52) U.S. Cl. 370/392

(57) ABSTRACT

A transmitter of network data sends packets with packet type tags in their headers to indicate to a receiver the data type, content type, or priority type of the packet so that packets that are not required by the host processor can be easily screened by the receiver, relieving the host processor of the processing of packets it does not need.

### FIELD OF THE INVENTION

This application relates to tagging network packets to indicate the type of content, data, or priority of the packet so that the packet may be pre-filtered by a receiver prior to requiring a processor downstream of the receiver to process the packet.

### BACKGROUND OF THE INVENTION

Networked devices such as computers can receive a great amount of data from the network. The processors of such devices clearly must process the data. As understood herein, much of the received data night not be required depending on the ambient usage of the device, but must nonetheless be processed by the receiving processor, and this is undesirable, particularly in the case of portable battery-powered devices.

### SUMMARY OF THE INVENTION

A method includes, for at least some data packets to be transmitted over a network, determining a packet type. The packet type indicates one or more of data type, content type, and priority type. The method also includes generating a data element indicating the type, inserting the data element into a header of the packet, and transmitting the packet. A data element may apply to one and only one packet or it may apply to plural packets.

The data type can be “video”, “audio”, or “binary application”. In contrast, the content type can be TV data, movie data, advertisement data, or personal data. On the other hand, the priority type can be real time, high priority, medium priority, best effort priority. In any case, a receiver of the packet can be programmed to recognize data elements indicating packet types such that packets that are not desired by a processor of the receiver are screened from the processor, thereby relieving the processor of processing packets that the processor does not require.

In another aspect, an apparatus includes a transmitter of network data in packets having headers. The apparatus further includes a processor controlling the transmitter to send packets with packet type tags in their headers to indicate to a receiver the data type, content type, or priority type of the packet so that packets that are not required by a host processor associated with the receiver are screened by the receiver, relieving the host processor of the processing of packets it does not need.

In another aspect, a tangible computer readable medium that is executable by a digital processor stores a data structure that includes a data packet body bearing data usable by a computer. The data structure further includes a data packet header including a packet identification and a packet type tag usable by a receiver to screen the packet.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example network device with filtering receiver;

FIG. 2 is a flow chart of example logic that can be implemented by the system of FIG. 1; and

FIG. 3 is a schematic diagram of an example packet in accordance with present principles.

### DETAILED DESCRIPTION OF THE PREFERRED EMBODIMENT

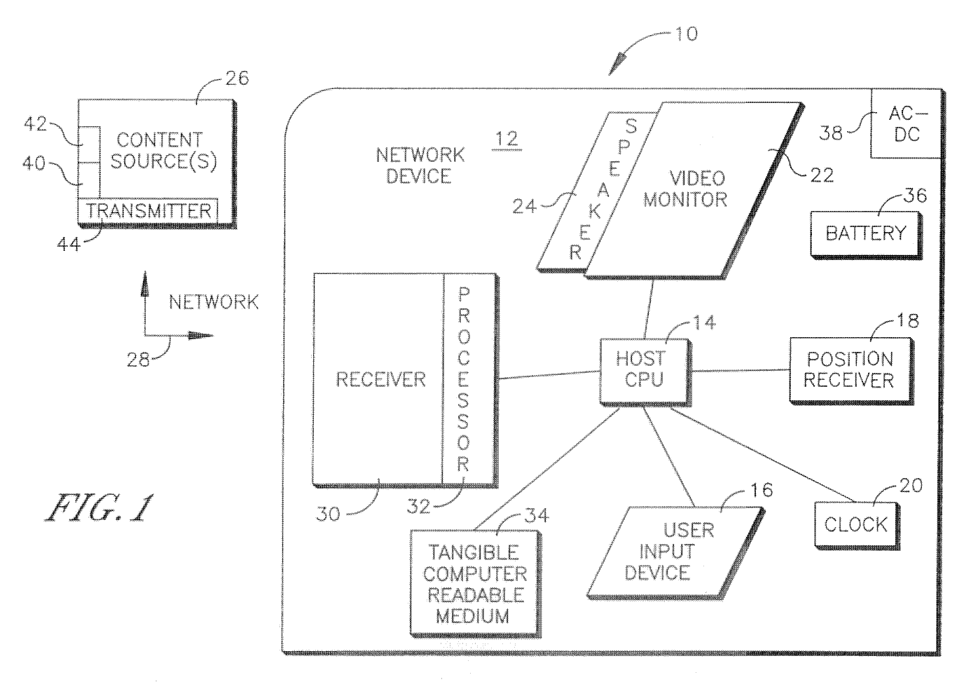

Referring initially to FIG. 1, a network device 10 may have a lightweight portable housing 12 containing a host central processing unit (CPU) 14 that can be implemented by, e.g., a suitable computer processor. The CPU 14 can receive user input from a user input device 16, such as but not limited one or more of a keyboard, mouse, keypad, trackball, voice recognition module, etc. The CPU 14 may also receive, in some embodiments, position input from a position receiver 18 such as but not limited to a global positioning satellite (GPS) receiver, and from a clock 20. The CPU 14 may output video data on a monitor 22 such as a computer monitor, flat panel display, or even cathode ray tube or other monitor, The CPU 14 can also output audio data on one or more speakers 24.

As shown in FIG. 1, the CPU 14 may receive data from content source(s) 26 over a network 28 such as but not limited to the Internet by means of a data receiver 30 with receiver processor 32. The receiver 30 may be a wired or wireless receiver that receives data packets from the network 28, with the packets typically bearing tags indicating their data type as set forth more fully below. Thus, the receiver 30 may include, without limitation, a wired modem or a wireless modem that may receive Bluetooth signals or WiFi signals. The receiver 30 may be implemented as a receiver module or integrated circuit, for example.

The CPU 14 may access a tangible computer readable storage medium 34 to store data thereon and to access computer instructions stored thereon. The medium 34 may represent, without limitation, any one or a combination of solid state storage, disk storage, removable and non-removable storage, etc.

As shown in FIG. 1, the components of the network device 10 may be powered by one or more direct current (DC) batteries 36, for portability. The network device 10 may also receive alternating current (AC) power from the AC grid through an AC-DC converter 38. In non-limiting implementations the network device 10 may be implemented as a portable computer such as a laptop or notebook computer, a personal digital assistant, or a wireless telephone.

FIG. 1 further shows that the content source 26 can include a source processor 40 accessing a source tangible computer readable storage medium 42 to store data thereon and to access computer instructions stored thereon to execute the logic herein. The medium 42 may represent, without limitation, any one or a combination of solid state storage, disk storage, removable and non-removable storage, etc. The source processor 40 can control a data transmitter 44 to send packets of data over the network 28. The data transmitter 44 can be any suitable network data transmitter such as a modem, broadcast transmitter, etc.

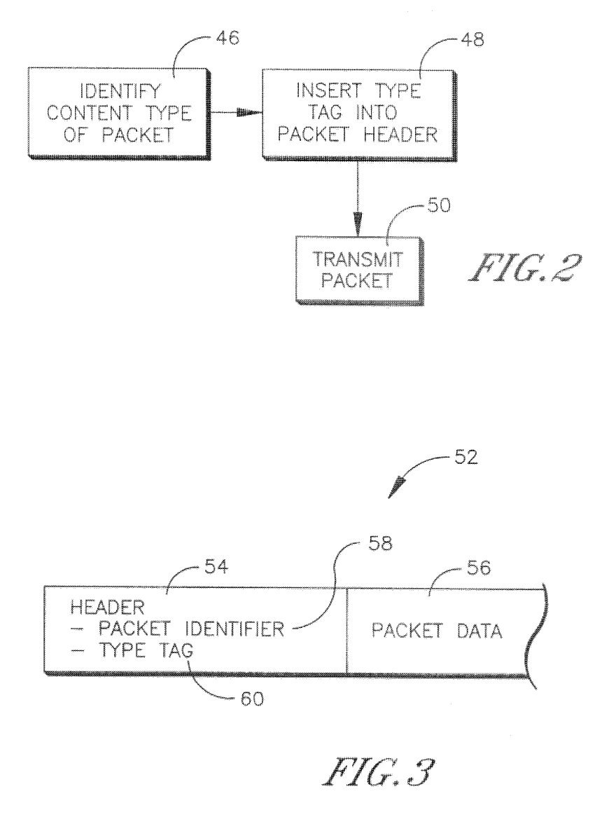

FIG. 2 illustrates logic that may be employed at least in part by the content source 26 shown in FIG. 1. Commencing at block 46, for each packet to be transmitted the packet type is determined. This determination may be made by the source processor 40 or by a prior system that provides data to the source 40.

“Type” generally refers to data type, content type, and priority type. By way of example, if the content is video data, the data type would be “video data”. In contrast, if the content is a software program, the data type may be “binary application”. Yet again, a “content” type that might be associated with the packet can include TV data, movie data, advertisement data, or personal data. Examples of packet priority type include real time, high priority, medium priority, best effort priority, etc. The type determinations may be made automatically by the source processor 40 based on characteristic data patterns in the packet or the determinations specified manually by a human expert. A packet may be designated with more than one type, e.g., a packet may be identified by both data type and content type or indeed by all three types, i.e., by data, content, and priority type.

Once the type(s) for the packet is determined, a data element, referred to herein as a “tag”, that designates the type(s) is generated and inserted into the header of tie packet at block 48. A tag may apply to one packet or to a group of packets, typically in sequence, with the number of packets to which the tag applies being indicated as part of the tag. The packet is then transmitted at block 50.

It is contemplated herein that network devices 10 that are programmed to recognize type tags in packets can quickly and easily decode the tags at their receiver to screen packets that might not be desirable from the main CPU 14 of the device. In this way, the CPU is relieved of processing packets that it might not require. Certain packet types such as, for example, emergency packet types night always be sent to the main CPU 14. The main CPU 14 may in effect command the receiver processor 32 to send to the main CPU 14 only packets of a certain type or types.

FIG. 3 shows a packet 52 that can include a header 54 and a packet body 56 containing packet data. The header 54 may include a packet identifier 58 and a type tag 60 that, in accordance with principles above, indicates the type of content in the packet body 56 and/or the type of data in the packet body 56 and/or the type of priority associated with the data in the packet body 56.

While the particular PACKET TAGGING FOR EFFECTIVE MULTICAST CONTENT DISTRIBUTION is herein shown and described in detail, it is to be understood that the subject matter which is encompassed by the present invention is limited only by the claims.

What is claimed is:

1. Method comprising:
for at least some data packets to be transmitted over a network, determining a packet type, the packet type indicating one or more of data type, content type, and priority type;
generating a data element indicating the type;
inserting the data element into a header of the packet; and
transmitting the packet.

2. The method of claim 1, wherein a data element applies to one and only one packet.

3. The method of claim 1, wherein a data element applies to plural packets.

4. The method of claim 1, wherein the data type is “video”, “audio”, or “binary application”.

5. The method of claim 1, wherein the content type is TV data, movie data, advertisement data, or personal data.

6. The method of claim 1, wherein the priority type is real time, high priority, medium priority, best effort priority.

7. The method of claim 1, wherein a receiver of the packet is programmed to recognize data elements indicating packet types such that packets that are not desired by a processor of the receiver are screened from the processor, thereby relieving the processor of processing packets that the processor does not require.

8. Apparatus, comprising:
a transmitter of network data in packets having headers; and
a processor controlling the transmitter to send packets with packet type tags in their headers to indicate to a receiver the data type, content type, or priority type of the packet so that packets that are not required by a host processor associated with the receiver arc screened by the receiver, relieving the host processor of the processing of packets it does not need.

9. The apparatus of claim 8, wherein the packet type indicates “video”, “audio”, or “binary application”.

10. The apparatus of claim 8, wherein the packet type indicates TV data, movie data, advertisement data, or personal data.

11. The apparatus of claim 8, wherein the packet type indicates real time, high priority, medium priority, best effort priority.

12. The apparatus of claim 8, wherein a tag applies to one and only one packet.

13. The apparatus of claim 8, wherein a tag applies to plural packets.

14. A tangible computer readable medium executable by a digital processor and storing a data structure comprising:
a data packet body bearing data usable by a computer; and
a data packet header including at least one packet identification and at least one packet type tag usable by a receiver to screen the packet.

15. The medium of claim 14, wherein the packet type tag indicates “video”, “audio”, or “binary application”.

16. The medium of claim 14, wherein the packet type tag indicates TV data, movie data, advertisement data, or personal data.

17. The medium of claim 14, wherein the packet type tag indicates real time, high priority, medium priority, best effort priority.

18. The medium of claim 14, wherein a tag applies to one and only one packet.

19. The medium of claim 14, wherein a tag applies to plural packets.
